(19) United States
(12) Patent Application Publication
(10) Pub. No.: US 2024/0428210 A1
(43) Pub. Date: Dec. 26, 2024

(54) UNSPENT-TRANSACTION-OUTPUT-BASED CENTRAL-BANK DIGITAL CURRENCY

(71) Applicant: International Business Machines Corporation, Armonk, NY (US)

(72) Inventors: Kaoutar El Khiyaoui, Zurich (CH); Angelo De Caro, Zurich (CH); Elli Androulaki, Zurich (CH)

(21) Appl. No.: 18/337,691

(22) Filed: Jun. 20, 2023

(51) Int. Cl. G06Q 20/06; G06Q 20/38; H04L 9/32

(52) U.S. Cl. CPC G06Q 20/0655; G06F 16/2379; G06F 21/64; G06Q 20/389; H04L 9/3218; H04L 9/3239; H04L 9/3247; G06Q 2220/00

(57) ABSTRACT

Extending an unspent-transaction-output-(UTXO)-based privacy-preserving token system to enable digital cash functionalities and privacy-preserving limit enforcement includes determining, by a central instance system, epochs of time-wise equally long and adjacent time periods, issuing, by the central instance system, digital cash tokens relating to a user-identifier, and storing a sum number of the issued digital cash tokens in an actual epoch relating to the user-identifier, preventing, by the central instance system, an issuing of digital cash tokens larger than a predefined maximum number of digital cash tokens relating to the user-identifier in the actual epoch, and resetting, by the central instance system, the sum number of issued tokens in the actual epoch at an end of the epoch.

### BACKGROUND

The present invention generally relates to the field of blockchain technology and distributed ledger, and more particularly to a method for extending a token system for digital cash.

The importance of digital currencies is increasing, while the use of hard cash is decreasing. In one example, the use of hard cash in some countries have declined to address health concerns. A variety of recent digital disruptions—including the emergence of crypto-currencies and blockchain technologies—have impacted the financial-service sector. Digital currencies are part of that trend, and central banks are interested in the trend and technology.

Central bank digital currencies (CBDCs) are the digital form of a government-issued currency that isn't pegged to a physical commodity. It is issued by central banks, whose role is to support financial services for a country's government and its commercial banking system, set monetary policies, and issue currency.

However, there is no one type of CBDC. Instead, a different of approaches are being experimented with in various countries. One type of CBDC is an account-based model (e.g., DCash™). Here, consumers hold deposit accounts directly with the central bank. On the other side, private-sector banks are involved in distributing and maintaining digital-currency accounts for their customers. A third model is currently being developed by the European Central Bank in which licensed financial institutions each operate a permissioned node of the blockchain network as a conduit for the distribution of a digital Euro.

The interest in CBDC is based on four main trends: (i) plummeting cash usage, (ii) growing interest in privately issued digital assets, (iii) decreasing sense of central banks as payment innovators, and (iv) rising of global payment systems. In particular, in context of the last point, many central banks seek to establish greater local governance over increasingly global payment systems. Central banks see therefore CBDC as a potential stabilizing anchor of local digital payment systems.

However, there are also concerns with CBDC. When money becomes digital, it also becomes traceable and, therefore taxable. This may represent a hurdle to voluntary adoption. Another issue may be a lack—as for now—of technological stability. The systems need to stay online permanently. There are also concerns regarding a positive business case for CBDC as many developed countries now activate instant payments using legacy (non-blockchain) infrastructures.

All in all, CBDC seems to have a future, but also lack some technical features like privacy of monetary transactions, especially for small amounts, as well as a potential deficiency of a system overload due to myriad of transactions having small or midsized amounts.

The so far known technologies are not able to close existing technology gaps in the context of CBDC. For example, existing unspent-transaction-output (UTXO)-based unlimited off-line transaction methods may include sending a digital currency wallet, a receiver digital currency wallet, and a digital currency registration center. The sender digital currency wallet is responsible for sending digital currency, the receiver digital currency, while it is a terminal equipment, for finally receiving the digital currency, and the digital currency registration center is a system which is responsible to be operated by a digital tow currency operator. The proposed scheme solves the problem that the digital currency received by the digital currency wallet under an off-line condition can be locked.

However, this method does not guarantee complete privacy, at least for those transactions having a transaction amount below a predefined maximum.

### SUMMARY

According to one aspect of the present invention, a method for extending an unspent-transaction-output-(UTXO)-based privacy-preserving token system to enable digital cash functionalities and privacy-preserving limit enforcement may be provided. The method may include determining, by a central instance system epochs of time-wise equally long and adjacent time periods, issuing by the central instance system digital cash credential relating to a user-identifier, and storing a sum number of the issued digital cash tokens in an actual epoch relating to the user-identifier. Additionally, the method may include preventing by the central instance system an issuing of digital cash tokens larger than a predefined maximum number of digital cash tokens relating to the user-identifier in the actual epoch and resetting by the central instance system the sum number of issued tokens in the actual epoch at an end of the epoch.

According to another aspect of the present invention, an unspent-transaction-output-(UTXO)-based privacy-preserving token system for enabling digital cash functionalities and privacy-preserving limit enforcement may be provided. The system may include one or more processors and a memory operatively coupled to the one or more processors, where the memory stores program code portions which, when executed by the one or more processors, enable the one or more processors to determine, by a central instance system, epochs of time-wise equally long and adjacent time periods, to issue by the central instance system digital cash credentials relating to a user-identifier, and to store a sum number of the issued digital cash tokens in an actual epoch relating to the user-identifier.

Moreover, the one or more processors may also be enabled to prevent by the central instance system an issuing of digital cash tokens larger than a predefined maximum number of digital cash tokens relating to the user-identifier in the actual epoch, and to reset by the central instance system the sum number of issued tokens in the actual epoch at an end of the epoch.

The proposed method for extending an unspent-transaction-output-(UTXO)-based privacy-preserving token system may offer multiple advantages, technical effects, contributions and/or improvements:

The proposed concept is able to deliver on the promise to match the idea of a central bank digital currency which—per definition—cannot guarantee privacy in respect to made transactions and the idea of unspent transaction output (UTX0) which may allow at least a minimum of privacy in an online digital world. The concept proposed here may allow to set a maximum up to which non-traceable transactions of digital cash may be made. This is not only good for the user community but also for a central institution, like a central bank, because the required decentralization and privacy protection requirements penalize transaction throughput and may increase latency of transactions. Because the central system remains the bottleneck and blockchain-based transactions—which are used by the underlying ledger system—are known to be comparatively slow.

The newly proposed concept circumvents this bottleneck. This advantage may be instrumental for the success of a CBDC because it has to compete with existing retail payment solutions at least in terms of performance.

Thus, small value transactions may be performed in a fully peer-to-peer fashion, such that cash payments may be emulated, i.e., manageable like digital cash. On the other side, large value transactions are subjected to an on-blockchain validation. Hence, both worlds can be merged, whereby the advantages of both worlds remain in place. I.e., the amount to be redeemed in the form of digital cash is obfuscated in the transaction message. Hence, the central instance system—i.e., the central bank—checks that the message m included in the transaction may be verified with respect to a zero-knowledge proof and the amount the user would like to be issued in terms of digital cash.

It shall also be mentioned that in the UXTO model, the central instance may only learn the amount of digital cash to be issued or deposited. It does not learn any information about the user's identity or the amount of digital cash they have been issued or have deposited so far. Important under privacy aspects: The central bank only learns that the user can be issued or can deposit digital cash. In this sense, the term “user identifier” shall be understood. Technically, it may be very difficult or impossible to issue digital cash to a user as a person. The amount of digital cash may be only digitally related to an identifier, i.e., the respective user identifier which has nothing to do with an ID card or the like.

Finally, the combined system may continue to guarantee its consistency under any circumstances. Double spending of digital cash is prevented as well as accidentally creating digital cash out of nothing. In other words, the newly proposed method and system is flexible, configurable, and safe and conformant with money-laundering requirements.

In the following, additional embodiments of the inventive concept—applicable for the method as well as for the system—will be described.

According to a useful embodiment, the method may also include storing a sum number of deposited digital cash tokens—in particular, of the user to the ledger system—in an actual epoch relating to the user-identifier and preventing a depositing—in particular to the underlying ledger system—of digital cash tokens larger than a predefined maximum number of digital cash tokens—typically denoted as “MaxDeposited”—from or relating to a user-identifier. Furthermore, this embodiment may also include resetting—in particular, setting to Zero—the sum number of deposited tokens in the actual epoch at an end of the epoch. This may help to ensure that only a limited number of digital cash tokens may be available for a user—or better related to a user identifier—during a given period of time, i.e., an epoch.

According to an advanced embodiment of the method, amounts larger than a predefined maximum digital cash value may be transferred from account to account using an underlying ledger system operated by the central instance system. Hence, these larger amounts may be transferred using the underlying ledger system, typically be based on blockchain technology, from user to user, i.e., —in electronic terms—from user identifier to user identifier.

According to another useful embodiment of the method, a user identifier may be registered by the central instance system-here, also denotable as “registration authority”—by determining a hiding commitment DC←(PK, eᵢ, issued, deposited, SN), where:
DC=digital cash credential (e.g., token),
PK=private key relating to the user identifier,
eᵢ=current epoch i,
issued [digital cash tokens] is set to 0,
deposited [digital cash tokens] is set to 0, and
SN=system unique serial number.

This partial process may ensure that a specific user, identifiable by its unique use identifier may participate in the privacy preserving UTXO-based central-bank digital currency. Without such a registration process, not any user may benefit from this new type of partly decentralized value management.

According to a preferred embodiment, the method may include engaging in an interactive protocol between the central instance system—in other words, the registration authority—and a system relating to the user identifier by proving knowledge of a secret key underlying the private key PK and the system unique serial number SN, proving that the hiding commitment DC encodes Zero in an issued and a deposited field and eᵢ as current epoch, determining by the central instance system—i.e., also here, the registration authority—that the registration is the first registration relating to the user identifier, and determining that the proving delivers a true outcome.

According to a further embodiment, the method may also include registering the user identifier, at the central instance system, by submitting a transaction: tx=(register, PK, DC, σ) to the underlying ledger system, wherein σ is a signature from the central instance system (i.e., registration authority). The registration process described so far for the user who can be identified by his user-identifier at the central instance system—here in the role of a registration office—may ensure that only a limited number of digital cash tokens may be available during a defined epoch, i.e., no proliferation of digital cash tokens may happen, and users can fairly rely on the underlying system to operate with fast response times. This may be possible, because only a limited number of transactions relating to the digital cash tokens are authorized by the underlying ledger system, i.e., the underlying blockchain.

According to an advantageous embodiment, the method may also include receiving a message m by the central instance system—in particular from the user identifiable by its user identifier—including an amount of digital cash tokens to be issued from a (in particular its own) ledger account. Upon a validity of a zero-knowledge proof in the context of the message m the method may include submitting, by the central instance system, a redeem transaction tx=(redeem, m, σ) to the underlying ledger system, where σ=is a central instance system's signature on (redeem, m) and “redeem”=type of transaction. Furthermore, this embodiment may include accepting the transaction by the ledger if required prerequisites are met and sending a message by the central instance system—in particular to the user using the registered address data—being indicative of a digital cash issuance.

Furthermore, the amount to be redeemed may be included in m and it may be obfuscated. The central instance may check that m verifies with respect to the zero-knowledge proof and the amount the user would like to be issued in terms of digital cash. The central instance also checks, using the zero-knowledge proof, that the maximum of issuance was not reached, otherwise, the request would be rejected.

In fact, and in more detail, for a redeem transaction a user sends a message to the central instance system, namely:
m=(tSN, SN, t′, t, DC′, DC, Π, Σ), where
t: is a randomization of a central instance system token—in particular a CBDC token—in the ledger and tSN is its serial number;
t′: encodes the same PK (private key) as t′ in the field “value in t′” equals the field value in
t—100, where “100” is used as an example for the redeemed amount;
DC: is a randomization of digital cash credentials in the ledger and SN is its serial number;
DC′: is a commitment to the same PK and epoch encoded in DC, and the field “issued in DC” equals “issued” in DC+100 (same example as above) and “issued” in DC′<MaxIssued. Hence, it is taken care of the requirement that the value of a number of “issued” is not larger than a maximum amount or maximum number of digital cash tokens allowed. Again, the number 100 used in the above description represents only an exemplary value. Any other value being compliant with the boundary conditions (e.g., MaxIssued) may be as good as the 100.

According to an additionally useful embodiment, the method may also include receiving a message m, by the central instance system—in particular, from a user or a related user system—including an amount of digital cash tokens to be deposited at an account, a signature σ, and a random message identifier. Then, as part of the same embodiment: upon determining, by the central instance system, that σ is a valid signature under its public key on the random message identifier.

Furthermore and upon determining, by the central instance system that the random message identifier was not used in a deposit transaction before and a valid Zero knowledge proof, the embodiment may include submitting by the central instance system a deposit transaction to the underlying ledger system, and accepting by the ledger system the deposit transaction if a token serial number, which is part of the deposit transaction, did not appear in the underlying ledger system before and the signature σ is valid.

In other words, this partial process of the digital cash deposit may be described in more detail by the following: the user sends to the central instance system a message m=(ID, σ, as SN, t, DC′, DC, Π, Σ), where:
Π is a Zero knowledge proof that shows that:
   DC is a randomization of a digital cash credentials in the underlying ledger system and as a serial number,
   DC′ is a commitment to the same PK and epoch in DC and the field “deposited” in DC equals the field “deposited” in DC+100, and “deposited in DC′<MaxDeposited.

Again, a value of 100 may be transferred from Bob to Alice in peer-to-peer fashion using digital cash received prior. And again, this portion of the optional method components may allow a conversion of digital cash tokens into value elements in the underlying ledger system, i.e., the underlying blockchain system.

According to a permissive embodiment, the method may also include a partial process for a periodic re-initialization by receiving a reinitializing transaction request by the central instance system, including a Zero as issued field and as deposited field and a message serial number, and accepting the re-initializing transaction request by the underlying ledger system if the message serial number did not appear in the ledger before.

Such a regular reset on epoch boundaries may include the following:

The user sends to the central instance system and message, namely:
m=(reinitialize, SN, DC, DC′, Π. Σ) to the ledger, where

Π is a ZK proof that shows that
DC is a randomization of a digital cash token in the ledger and SN is its serial number,
DC′ is a commitment to the same PK in DC,
DC encodes current epoch and DC encodes a past epoch
DC′ encodes 0 in “issued” and “deposited”, and
Σ is a valid anonymous signature relative PK encoded in DC.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating, or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method-type claims, whereas other embodiments are described with reference to apparatus-type claims. However, a person skilled in the art will gather from the above and the following description that, unless otherwise notified, in addition to any combination of features belonging to one type of subject matter, also any combination between features relating to different subject matters, in particular, between features of the method-type claims, and features of the apparatus-type claims, is considered as to be disclosed within this document.

The aspects defined above and further aspects of the present invention are apparent from the examples of embodiments to be described hereinafter and are explained with reference to the examples of embodiments to which the invention is not limited.

Preferred embodiments of the invention will be described, by way of example only, and with reference to the following drawings:

FIG. 1 shows a block diagram of an embodiment of the inventive method for extending an unspent-transaction-output-(UTXO)-based privacy-preserving token system;

FIG. 2 shows a diagram of an exemplary transaction for a central bank digital currency, according to an embodiment of the present invention;

FIG. 3 shows a diagram symbolizing that all inputs and outputs can be hidden, according to an embodiment of the present invention;

FIG. 4 shows a three-part diagram showing the constituents of digital cash, namely, the central bank (CB) and users, according to an embodiment of the present invention;

FIG. 5 shows a separation of the flow of time into different epochs, according to an embodiment of the present invention;

FIG. 6 shows the set-up and registration process for the privacy of privacy-preserving limit enforcement for digital cash, according to an embodiment of the present invention;

FIG. 7 shows the process of a CBDC redeem process, according to an embodiment of the present invention;

FIG. 8 shows the process of a digital cash deposit, according to an embodiment of the present invention;

FIG. 9 shows the process of an epoch update, according to an embodiment of the present invention;

FIG. 10 shows a block diagram of an embodiment of the inventive unspent-transaction-output-(UTXO)-based privacy-preserving token system for enabling digital cash functionalities and privacy-preserving limit enforcement; and

FIG. 11 shows an embodiment of a computing system including the system according to FIG. 10.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention generally relates to a method for extending a token system for digital cash, and more specifically, to a method for extending an unspent-transaction-output-(UTXO)-based privacy-preserving token system. The invention relates further to an unspent-transaction-output-(UTXO)-based privacy-preserving token system for enabling digital cash functionalities and privacy-preserving limit enforcement, and a computer program product.

In the context of this description, the following technical conventions, terms and/or expressions may be used:

The term ‘unspent-transaction-output’—in short: UTXO—may denote in the field of crypto-currencies some amount of digital currency which has been authorized by one account to be spent by another. UTXOs use public key cryptography to identify and transfer ownership between orders of public/private key pairs and are formatted with the recipient's public key. Hence, this is instrumental for restricting the ability to spend that UTXO to the account that cannot prove ownership of the associated private key.

The term ‘privacy-preserving’ may denote that no digital trace may be left when transferring digital cash tokens from one user to another. It may not be recorded in a central bank blockchain-based ledger system.

The term ‘digital cash’ may denote here the ability to spend digital cash tokens like real money, i.e., in a privacy preserving manner, i.e., basically not generating any traceable information.

The term ‘privacy-preserving limit enforcement’ may denote here that the spending and/or exchanging of cash tokens may be restricted to a maximum in a given time period, e.g., a month (or any other predefined amount of time).

The term ‘central instance system’ may denote here, e.g., a central bank using a computer system for managing an issuance of digital cash tokens related to an account in a centralized or decentralized blockchain-based ledger system. A user in that system may be identifiable using a user-identifier, i.e., a unique code.

The term ‘epochs of time-wise equally long and adjacent time periods’ may denote that the continuous stream of time is separated into distinct intervals without time periods not belonging to it.

The term ‘digital cash token’ may denote a digital code—typically, encrypted—belonging to a digital value or currency exchange system where the digital cash token may represent a related monetary value.

The term ‘user-identifier’ may denote a digital code which may be related to a specific user.

The ‘term digital cash credential’ may denote a digital code—typically, signed and encrypted—which is related to a specific user, i.e., user-identifier.

The term ‘sum number’ may denote a number representing a count instead of an amount in the sense of a monetary amount.

The term ‘predefined maximum number’ may denote here, a number of digital cash tokens that should not be exceeded in a predefined amount of time, i.e., an epoch. Hence, each user of the underlying system should not be allowed to redeem and spend more than a predefined maximum number of such digital cash tokens.

The term ‘underlying ledger system’ may denote e.g., a block-chain-based decentralized ledger system allowing a secure exchange of digital monetary tokens like, e.g., Bitcoin, Ethereum or others.

In the following, a detailed description of the figures will be given. All instructions in the figures are schematic. Firstly, a block diagram of an embodiment of the inventive method for extending an unspent-transaction-output-(UTXO)-based privacy-preserving token system is given. Afterwards, further embodiments, as well as embodiments of the unspent-transaction-output-(UTXO)-based privacy-preserving token system for enabling digital cash functionalities and privacy-preserving limit enforcement will be described.

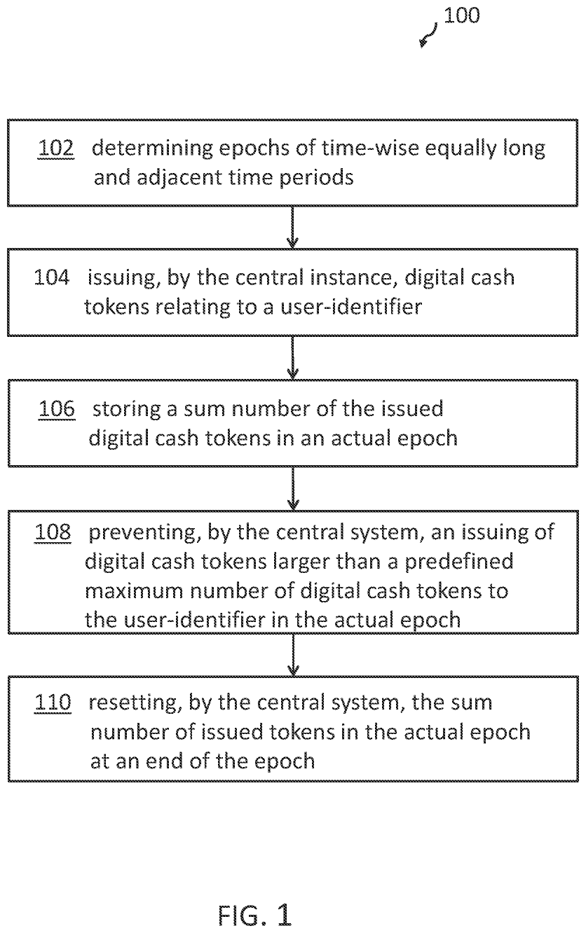

FIG. 1 shows a block diagram of a preferred embodiment of the method 100 for extending an unspent-transaction-output-(UTXO)-based privacy-preserving token system. The method 100 includes determining. 102—to be understood in the sense of “defining”—by a central instance system, epochs of time-wise equally long and adjacent time periods, i.e., the time is split into equally long epochs. The central instance system may be used as synonym for a computer system at a bank, e.g., a central bank.

The method 100 also includes issuing. 104, by the central instance system, digital cash tokens—in particular not only once, but optionally several times—relating to a user-identifier, i.e., relating to a user of the ledger system—and storing. 106 a sum number of the issued digital cash tokens in an actual epoch relating to the user-identifier. This is instrumental for knowing how many tokens have been issued to a user in a time epoch.

The method additionally includes, preventing 108, by the central instance system, an issuing of digital cash tokens larger than a predefined maximum number of digital cash tokens—denotable as the configurable variable “MaxIssued—relating to the user-identifier in the actual epoch, and resetting, 110—i.e., in the sense of “set to zero”—by the central instance system the sum number of issued tokens in the actual epoch at an end of the epoch. Furthermore, it may be understood that not the value represented by the tokens is destroyed/deleted but only the number of tokens that have issued in the epoch.

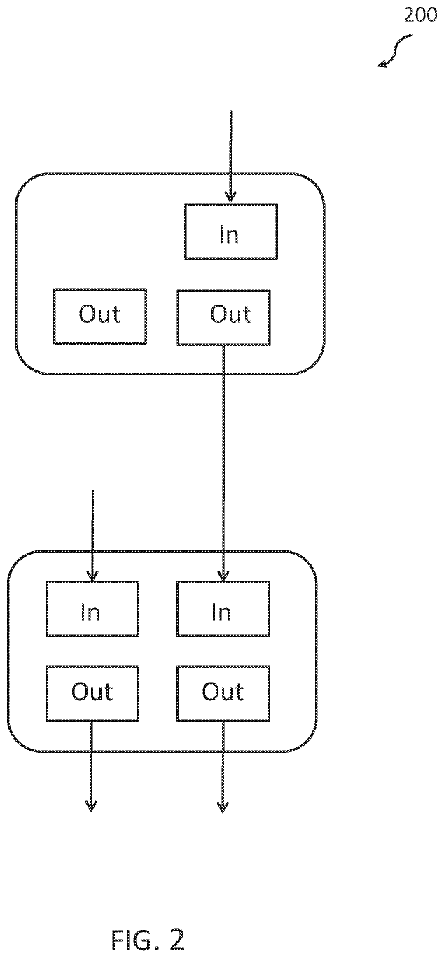

FIG. 2 shows a diagram 200 of an exemplary transaction for a central bank digital currency, i.e., CBDC transfer. Exemplary, transaction 55, 202 (TX 55) has inputs (one of which inputs 206 is shown) and two outputs 208. As an example, one of the outputs 208 is assigned a value of 50 USD. This is used as input for another subsequent transaction, e.g., transaction TX 100, 204. Additionally, 9 USD are received as another input for this transaction 204. In total, this transaction has input values of 59 USD. Again, as an example, the output of the transaction is split into the values of 53 USD and 9 USD. Thus, the sum of the input values of a transaction and related outputs of the same transaction has to be identical.

Other conditions for performing such kinds of transactions are the following: a user or, equivalently a user ID, is each assigned a pair of public and private keys. If digital cash shall be issued (i.e., an initial issue process), the input values of the transactions are set to zero and the output values are set turn array of CBDC tokens. Thereby, the token defines the owner—in particular, by its public address or ID—and a value. Furthermore, the central bank's signature is required.

As validation rule, it may only be required to prove that the signature is valid before the output can be added.

In order to execute a transfer transaction, it is required to use as input values output values from previous transactions. Outputs are again an array of CBDC tokens as well as signatures of the owners of inputs. In order to validate such a transfer transaction, it is required to prove that the signatures are valid to ensure that the values are preserved and that inputs were not spent before, because this would mean that double-spending would have happened. However, the proposed concept also allows a double-spending detection with the consequence that inputs and added outputs are deleted.

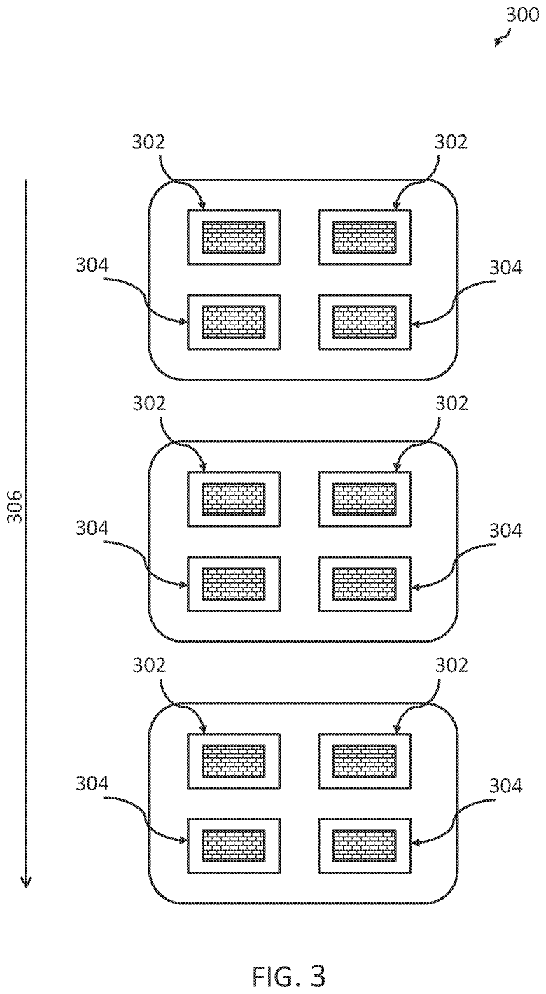

In contrast to FIG. 2, FIG. 3 shows a diagram 300 symbolizing that all inputs and outputs can be hidden, symbolized by the artificial break walls within the transaction input and output boxes 302, 304.

Thereby, a CBDC token, and the ledger, is a hiding commitment t←commit (PK, value, tSN), where:
PK=the public key of the token owner,
value=value of digital cash to be transferred, and
tSN=serial number that uniquely identifies the token which is only known to the owner (i.e., token serial number).

A Zero-knowledge proof must show that the value is preserved and that tokens being consumed are recorded in the ledger system, in particular using a signature-based membership proof. Thereby, the serial numbers are revealed at the time of the transfer which helps to detect double spending. Furthermore, anonymous signatures prove an ownership of tokens being consumed without revealing the identities of the owners. Exactly this is symbolized by the brick-like symbols of FIG. 3 within the sequence of transactions 306.

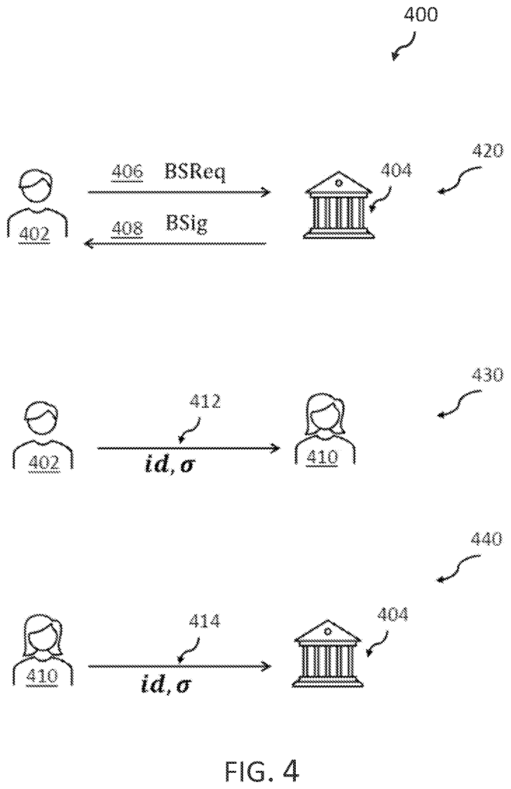

FIG. 4 shows a three-part diagram 400—with the components 420, 430, 440 showing the constituents of digital cash, namely, the central bank (CB) and users which are in digital systems typically identified and managed as user IDs.

Partial diagram 420 deals with the issue of digital cash, i.e., single denomination. For this, the user (i.e., user ID) generates a blind signature request BSReq for an identifier id, which is randomly picked. The central bank 404 responds by signing the BSReq 406 and returning the result BSig 408. At the same time, the user account is debited.

Partial diagram 430 relates to a transfer 412 of the digital cash from user 402, identifiable by its user ID, to another user 410 (also denoted as Bob). The transfer can be processed if it can be verified that σ is a valid signature on id relative to the central banks public key.

Partial diagram 440 reveals details of a deposit process 414, performed by user 410 to its account with the central bank 404. Here, it is required to verify if σ is a valid signature on id relative to the central banks public key. Furthermore, it needs to be checked if the id already appears in its deposit database in order to detect double spending. If this is not the case, the amount of digital cash is credited to the user account of user 410 (also denoted as Alice).

The two different scenarios, shown as ledger transactions in FIG. 2 and the digital cash procedure according to FIG. 4 need to be brought together in order to achieve the advantages of the above-described inventive privacy-preserving limit enforcement for digital cash process in the context of CBDC.

Thereby, the process is the following: (i) to issue 100 USD digital cash for Alice the central bank redeems 100 USD from Alice's tokens in the CBDC ledger; (ii) then, Alice and the central bank engage in a digital cash issuance protocol; (iii) next, Ella 100 USD in a peer-to-peer fashion (i.e., anonymously); (iv) then, Bob deposits 100 USD in digital cash with the central bank; (v) finally, the central bank checks for digital cash double spending, and if it is not detected, it issues Bob a 100 USD token in the CBDC ledger.

Thus, at least two challenges need to be overcome with the proper solutions. Firstly, the total value of digital cash transactions during each epoch (i.e., time period) does not exceed a predefined and configurable limit. Hence, the limit for the digital cash issuance and digital cash deposits need to be defined, i.e., configured, in advance. Secondly, user privacy should be preserved. This is achieved by hiding commitments and the Zero-knowledge proves (ZKP) at time of issuance and deposit.

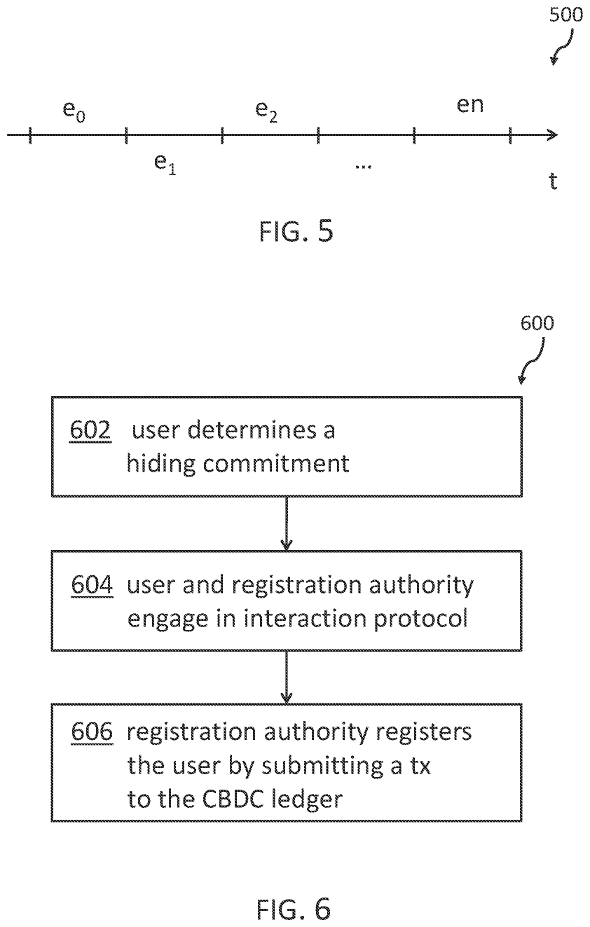

FIG. 5 shows a diagram 500 of separation of the flow of time into different epochs, e₀, e₁, e₂ . . . eₙ. The length of the epochs is configurable. It could, e.g., be a week, a month, or a quarter of the year. A useful term seems to be a month.

FIG. 6 shows the set-up 600 and registration process for the privacy of privacy-preserving limit enforcement for digital cash. One of the prerequisites is to divide the time into different epochs as shown in the context of FIG. 5. Furthermore, it is advisable to define the amount of cash that the user can be issued during an epoch, namely a MaxIssued value. Furthermore, it is also necessary useful to define the amount of digital cash that the user is allowed to deposit during the epoch, namely, MaxDeposited.

In order to register, a user—or better the process related to a user ID—determines, 602, a hiding commitment:
DC←(commit (PK, eᵢ, issued, deposited, SN), where
eᵢ is the current epoch, “issued” and “deposited” is set to Zero, SN is a unique serial number, so that DC becomes a digital cash token.

The user and the registration authority—typically, a central instance, a central system, i.e., the central bank—engage, 604, in an interactive protocol in which (i) the user proves knowledge of the secret key SK, underlying the private key PK and SN shows that DC encodes Zero in “issued” and “deposited” fields and eᵢ as epoch.

Next (ii), the registration authority checks that this is the first time the user is registering and that the proof is correct. Then, the registration authority registers, 606, the user by submitting a transaction tx=(register, PK, DC, σ) to the CBDC ledger, where σ is a signature from the registration authority, i.e., the central bank.

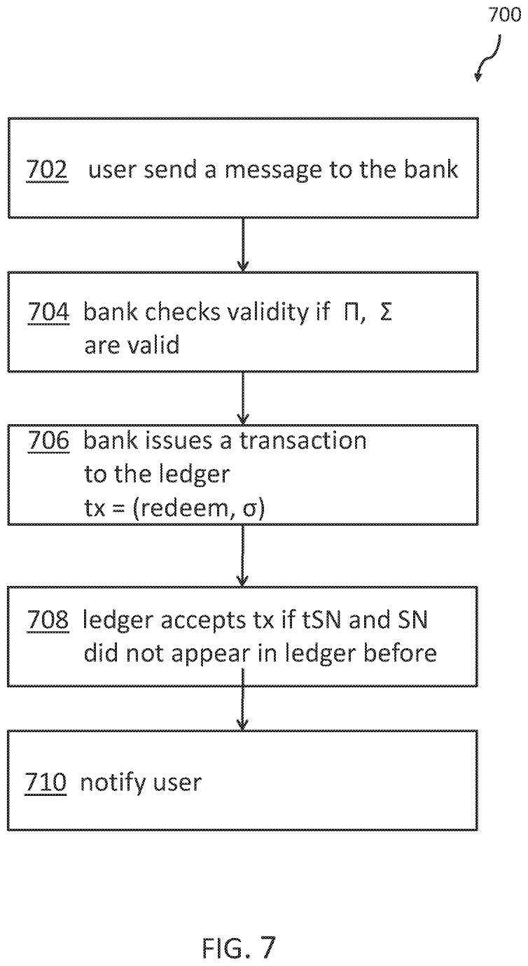

FIG. 7 shows the process of a CBDC redeem process 700. Firstly, the user sends, 702, a message to the central bank: m=(tSN, SN, T′, t, DC′, DC, Π, Σ) such that (i) Π is a ZK proof that shows that:
t is a randomization of a CBDC token in the leger and tSN is its serial number;
t′ encodes the same PK as t′ and the field “value” in t equals the field value in t—100, where 100 is used as a redeem example of 100 USD (any other number below the MaxIssued value would be allowable);
DC is a randomization of a digital cash token in the ledger and SN is its serial number;
DC′ is a commitment to the same PK and epoch encoded in DC, and the field “issued” in DC′ equals “issued” in DC+100 and “issued” in DC′<MaxIssued;
DC and t encode the same private key PK; and
(ii) Σ is a valid anonymous signature relative to PK encoded in CBDC token t.

Then, the central bank checks, 704, if Π and Σ are valid, and if so, then the central bank submits or issues, 706, a transaction tx=(redeem, m, σ) to the underlying ledger system, where σ is the central bank's signature on (redeem, m, σ) and “redeem” defines the type of operation.

Furthermore, the ledger system accepts, 708, tx if tSN and SN did not appear in the ledger before—i.e., double spending check.

Finally, the central bank—or better its underlying system (which is always assumed) —notifies, 710, the user.

This way, the central bank issuing the digital cash and user have engaged in digital cash issuance for 100 USD (as example).

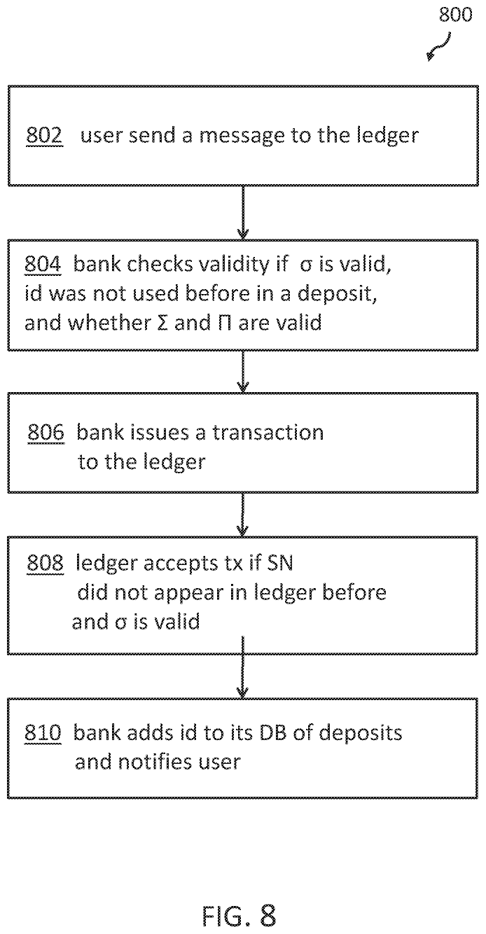

FIG. 8 shows a process 800 of a digital cash deposit. The process 800 starts by sending, 802, a message to the ledger, initiated by the user, i.e., represented by the user identifier. The message has the form of:
m=(id, σ, SN, t, DC′, DC, Π, Σ), such that
   Π is a ZK proof that shows that:
DC is a randomization of a digital cash token in the ledger and SN is its serial number,
DC′ is a commitment to the same PK and epoch in DC and the field “deposited in DC equals the field “deposited in DC+100 and deposited in DC′<MaxDeposited,
t encodes the same PK as DC and “value of t equals 100”, and
Σ is a valid anonymous signature relative to PK encoded in DC.

It should be understood that the value of 100 is selected as example in order to show how to reach the 100 value and digital cash can be deposited. Additionally, the value “MaxDeposited” is one of the configurable variables of the proposed method. It represents the maximum value that can be deposited or converted from private preserving digital cash to a transaction in the underlying ledger system.

After this, the central instance system (e.g., the central bank) checks, 804, whether (i) σ is a valid signature of that public key on message id, (ii) ID was used in a deposit before, and (iii) Π and Σ are valid.

Then, the central instance system submits, 806, the following transaction to the underlying ledger system where σ′ is a signature of the central instance system (i.e., the central bank):
TX=(issue, SN, t, DC′, DC, Π, Σ).

Next, the ledger accepts, 808, the transaction, if SN did not appear in the underlying ledger system before and σ′ is valid. Last but not least, the central instance system adds, 810, id to its database of deposits and notifies the user, represented by the user identifier.

In order to make the proposed method a workable solution, another process will be discussed that focuses on an epoch update.

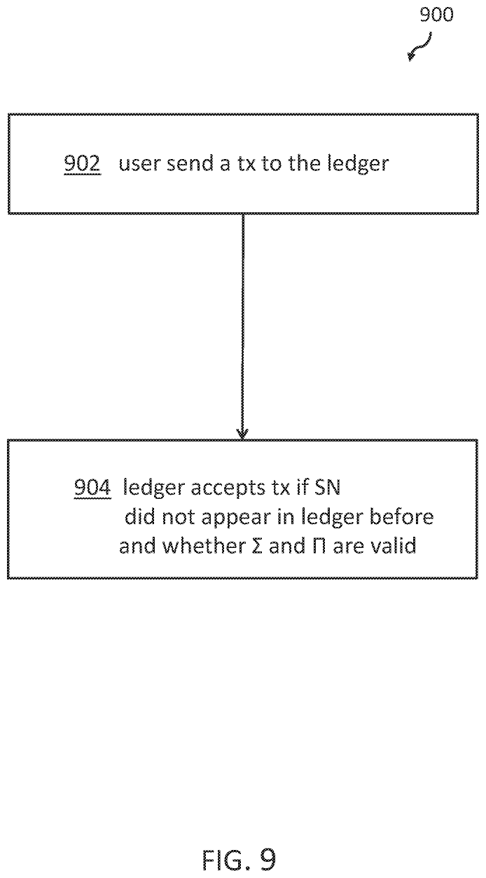

FIG. 9 shows a process 900 of an epoch update. When in epoch elapses, the user is allowed to reinitialize the value on the number of DC. Typically, this would mean setting the value/number of “issued” and “deposited” to Zero.

For this, the user submits, 902, a transaction, namely:
tx=(reinitialize, as in, DC, DC′, Π, Σ).

Thereby, Π is a zero knowledge prove that shows that:
DC is a randomization of a digital cash token in the underlying ledger system and SN is a serial number;
DC′ is a commitment to the same PK (i.e., private key) in DC;
DC′ encodes the current epoch and DC encodes a past epoch (i.e., the one before);
DC encodes 0 in the variables “issued” and “deposited”; and
Σ is a valid anonymous signature relative to PK encoded in DC.

As a response, the underlying ledger system accepts, 904, the transaction tx if SN did not appear in the underlying ledger system before and Π and Σ are valid.

Based on the token DC, a user can only be issued up to the configurable value of MaxIssued and deposit up to MaxDeposit in each single epoch.

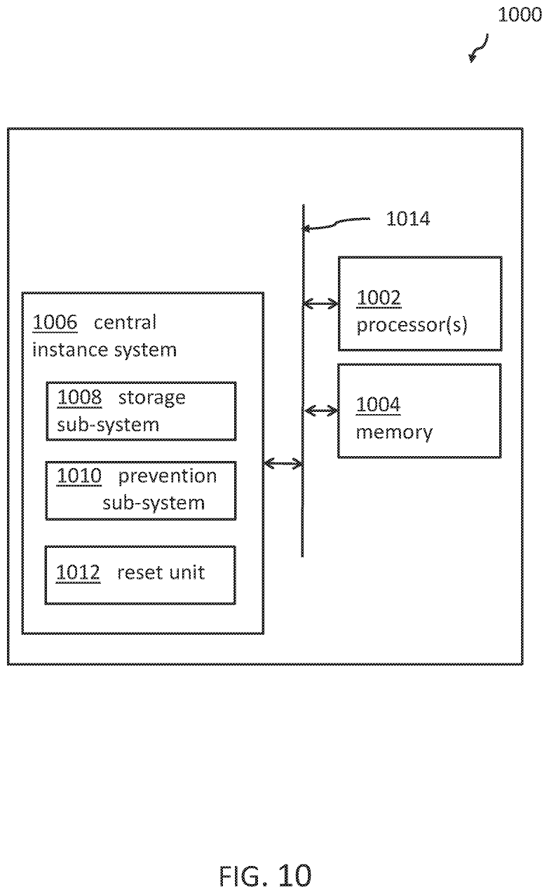

FIG. 10 shows a block diagram of an embodiment of the unspent-transaction-output-(UTXO)-based privacy-preserving token system 1000 for enabling digital cash functionalities and privacy-preserving limit enforcement from another perspective. The system 1000 includes one or more processors 1002 and a memory 1004 operatively coupled to the one or more processors 1002, where the memory 1004 stores program code portions which, when executed by the one or more processors 1002, enable the one or more processors 1002 to determine—in particular, using components of the central instance system 1006, epochs of time-wise equally long and adjacent time periods, to issue—in particular also buy components of the central instance system 1006—digital cash tokens relating to a user-identifier, and to store—in particular, by a storage sub-system 1008 of the central instance system 1006—a sum number of the issued digital cash tokens in an actual epoch relating to the user-identifier.

Additionally, the one or more processors 1002 are also enabled to prevent—in particular, by a prevention sub-system 1010 by the central instance system 1006—an issuing of digital cash tokens larger than a predefined maximum number of digital cash tokens relating to the user-identifier in the actual epoch, and reset, in particular, by a reset unit 1012 of the central instance system 1006—the sum number of issued tokens in the actual epoch at an end of the epoch.

It shall also be mentioned that all functional units, modules, and functional blocks—in particular, the processors 1002, the memory 1004, the central instance system 1006, the storage sub-system 1008, the prevention sub-system 1010, and the reset unit 1012—may be communicatively coupled to each other for signal or message exchange in a selected 1:1 manner. Alternatively, the functional units, modules and functional blocks can be linked to a system internal bus system 1014 for a selective signal or message exchange.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

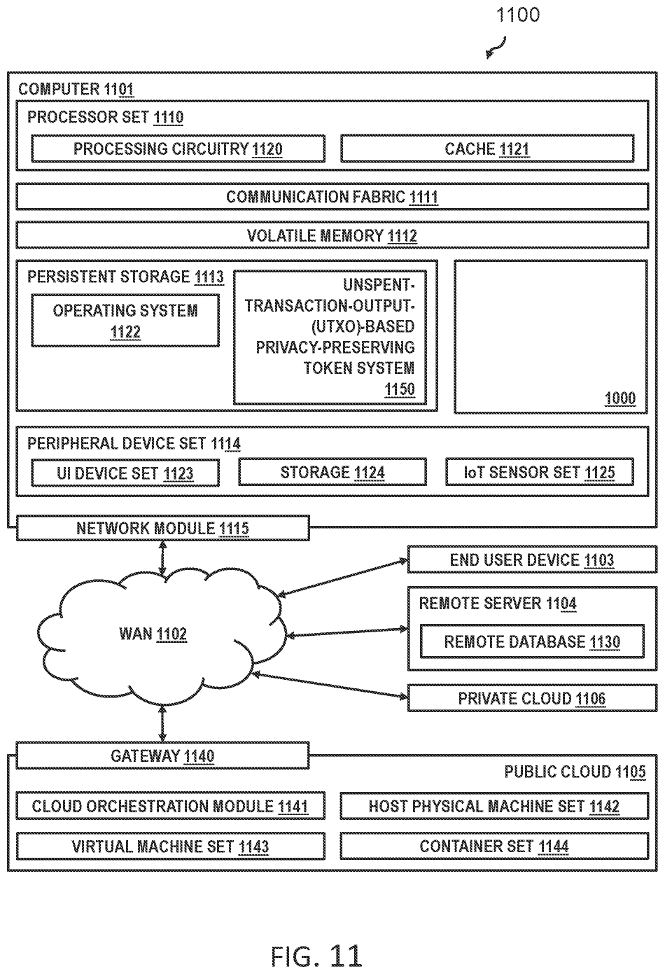

FIG. 11 shows a computing environment 1100 including an example of an environment for the execution of at least some of the computer code involved in performing the inventive methods, such as the method for extending an unspent-transaction-output-(UTXO)-based privacy-preserving token system 1150.

In addition to block 1150, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1150, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1150 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid-state storage devices. Operating system 1122 may take several forms, such as various known proprietary operating systems or open-source Portable Operating System Interface type operating systems that employ a kernel. The code included in block 1150 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (e.g., embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

It should also be mentioned that the unspent-transaction-output-(UTXO)-based privacy-preserving token system 1150 for enabling digital cash functionalities and privacy-preserving limit enforcement can also be an operational sub-system 1000 of the computer 1101 and may be attached to a computer-internal bus system.

The terminology used herein is for the purpose of describing particular embodiments only and is not intended to limit the invention. As used herein, the singular forms a, an, and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed.

The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

What is claimed is:

1. A computer-implemented method for extending an unspent-transaction-output-(UTXO)-based privacy-preserving token system, comprising
determining, by a central instance system, epochs of equally long and adjacent time periods;
issuing, by the central instance system, digital cash tokens related to a user-identifier;
storing a sum number of the issued digital cash tokens in an actual epoch related to the user-identifier;
preventing, by the central instance system, an issuing of digital cash tokens larger than a predefined maximum number of digital cash tokens relating to the user-identifier in the actual epoch; and
resetting, by the central instance system, the sum number of issued tokens in the actual epoch at an end of the actual epoch.

2. The method according to claim 1, further comprising:
storing a sum number of deposited digital cash tokens in the actual epoch related to the user-identifier;
preventing a depositing of digital cash tokens larger than a predefined maximum number of digital cash tokens from a user-identifier; and
resetting the sum number of deposited tokens in the actual epoch at the end of the epoch.

3. The method according to claim 1, wherein amounts larger than a predefined maximum digital cash value are transferred from one account to another account using an underlying ledger system operated by the central instance system.

4. The method according to claim 1, wherein the user-identifier is registered by the central instance system by:
determining a hiding commitment DC←(PK, eᵢ, issued, deposited, SN), wherein
DC=digital cash credential,
PK=private key relating to said user identifier,
eᵢ=current epoch,
issued [digital cash tokens] is set to 0,
deposited [digital cash tokens] is set to 0, and
SN=system unique serial number.

5. The method according to claim 4, further comprising:
engaging in an interactive protocol between the central instance system and a system relating to the user-identifier by:
proving knowledge of a secret key underlying the private key PK and the system unique serial number SN;
proving that the hiding commitment DC encodes Zero in an issued and a deposited field and eᵢ as current epoch;
determining by the central instance system that the registration is the first registration relating to the user identifier; and
determining that the proving delivers a true outcome.

6. The method according to claim 5, further comprising:
registering the user identifier at the central instance system by submitting a transaction
tx=(register, PK, DC, σ) to the underlying ledger system, wherein σ is a signature from the central instance system.

7. The method according to claim 6, further comprising
receiving a message m by the central instance system including an amount of digital cash tokens to be issued from a ledger account;
upon a validity of a zero knowledge proof in the context of the message m, submitting, by the central instance system, a redeem transaction tx=(redeem, m, σ) to the underlying ledger system, wherein σ=a central instance system's signature on (redeem, m), redeem=type of transaction;
accepting the transaction by the distributed ledger system if required prerequisites are met; and
sending a message by the central instance system being indicative of a digital cash issuance.

8. The method according to claim 6, further comprising
receiving a message m by said central instance system including an amount of digital cash tokens to be deposited at an account, a signature σ, and a random message identifier;
upon determining, by the central instance system, that σ is a valid signature under its public key on the random message identifier;
upon determining, by the central instance system, that the random message identifier was not used in a deposit transaction before and a valid Zero knowledge proof;
submitting, by the central instance system, a deposit transaction to the underlying ledger system; and
accepting, by the ledger system, the deposit transaction if a token serial number which is part of the deposit transaction did not appear in the underlying ledger system before and the signature σ is valid.

9. The method according to claim 6, further comprising:
receiving a reinitializing transaction request, by the central instance system, comprising a Zero as issued field and as deposited field and a message serial number; and
accepting the reinitializing transaction request by the underlying ledger system if the message serial number did not appear in the ledger before.

10. A unspent-transaction-output-(UTXO)-based privacy-preserving token system, comprising:
one or more processors and a memory operatively coupled to t one or more processors, wherein said memory stores program code portions which, when executed by said one or more processors, enable said one or more processors to:
determine, by a central instance system, epochs of equally long and adjacent time periods;
issue, by the central instance system, digital cash tokens related to a user-identifier;
store a sum number of the issued digital cash tokens in an actual epoch related to the user-identifier;
prevent, by the central instance system, an issuing of digital cash tokens larger than a predefined maximum number of digital cash tokens relating to the user-identifier in the actual epoch; and
reset, by the central instance system, the sum number of issued tokens in the actual epoch at an end of the epoch.

11. The system according to claim 10, wherein the one or more processors are further enabled to:
store a sum number of deposited digital cash tokens in the actual epoch related to the user-identifier;
prevent a depositing of digital cash tokens larger than a predefined maximum number of digital cash tokens from a user-identifier; and
reset the sum number of deposited tokens in the actual epoch at the end of the epoch.

12. The system according to claim 10, wherein amounts larger than a predefined maximum digital cash value are transferred from one account to another account using an underlying ledger system operated by the central instance system.

13. The system according to claim 10, wherein said one or more processors are also enabled to register a user identifier by the central instance system by:
determining a hiding commitment DC←(PK, eᵢ, issued, deposited, SN), wherein
DC=digital cash credential,
PK=private key relating to said user identifier,
eᵢ=current epoch,
issued [digital cash tokens] is set to 0,
deposited [digital cash tokens] is set to 0, and
SN=system unique serial number.

14. The system according to claim 13, wherein said one or more processors are also enabled to:
engage in an interactive protocol between the central instance system and a system relating to the user-identifier by:
proving knowledge of a secret key underlying the private key PK and the system unique serial number SN;
proving that the hiding commitment DC encodes Zero in an issued and a deposited field and eᵢ as current epoch;
determining by the central instance system that the registration is the first registration relating to the user identifier; and
determining that the proving delivers a true outcome.

15. The system according to claim 14, wherein said one or more processors are also enabled to:
register the user identifier, at the central instance system by submitting a transaction
tx=(register, PK, DC, σ) to the underlying ledger system, wherein σ is a signature from the central instance system.

16. The system according to claim 15, wherein said one or more processors are also enabled to:
receiving a message m by the central instance system including an amount of digital cash tokens to be issued from a ledger account;
upon a validity of a zero knowledge proof in the context of the message m, submitting, by the central instance system, a redeem transaction tx=(redeem, m, σ) to the underlying ledger system, wherein σ=a central instance system's signature on (redeem, m), redeem=type of transaction;
accepting the transaction by the distributed ledger system if required prerequisites are met; and
sending a message by the central instance system being indicative of a digital cash issuance.

17. The system according to claim 16, wherein said one or more processors are also enabled to:
receiving a message m by said central instance system including an amount of digital cash tokens to be deposited at an account, a signature σ, and a random message identifier;
upon determining, by the central instance system, that σ is a valid signature under its public key on the random message identifier;
upon determining, by the central instance system, that the random message identifier was not used in a deposit transaction before and a valid Zero knowledge proof;
submitting, by the central instance system, a deposit transaction to the underlying ledger system; and
accepting, by the ledger system, the deposit transaction if a token serial number which is part of the deposit transaction did not appear in the underlying ledger system before and the signature σ is valid.

18. The system according to claim 16, wherein said one or more processors are also enabled to:
receiving a reinitializing transaction request, by the central instance system, comprising a Zero as issued field and as deposited field and a message serial number; and
accepting the reinitializing transaction request by the underlying ledger system if the message serial number did not appear in the ledger before.

19. A computer program product for an unspent-transaction-output-(UTXO)-based privacy-preserving token system, comprising:
a computer readable storage medium having program instructions embodied therewith, said program instructions being executable by one or more computing systems or controllers to cause said one or more computing systems to:
determine, by a central instance system, epochs of equally long and adjacent time periods;
issue, by the central instance system, digital cash tokens related to a user-identifier;
store a sum number of the issued digital cash tokens in an actual epoch related to the user-identifier;
prevent, by the central instance system, an issuing of digital cash tokens larger than a predefined maximum number of digital cash tokens relating to the user-identifier in the actual epoch; and
reset, by the central instance system, the sum number of issued tokens in the actual epoch at an end of the epoch.
